(19) United States
(12) Patent Application Publication
(10) Pub. No.: US 2013/0098935 A1
(43) Pub. Date: Apr. 25, 2013

(54) Ammunition Magazine Holder

(71) Applicant: Adam Sheffield, Rancho Santa Margarita, CA (US)

(72) Inventor: Adam Sheffield, Rancho Santa Margarita, CA (US)

(21) Appl. No.: 13/281,365

(22) Filed: Oct. 25, 2011

(51) Int. Cl. F42B 39/26; B65G 59/00

(52) U.S. Cl. 221/1; 221/154

(57) ABSTRACT

A system and apparatus for storing ammunition comprises a hard-bodied capsule for ejectably retaining an ammunition magazine in a substantially water-resistant compartment thereof.

### CROSS-REFERENCE TO RELATED APPLICATIONS

None.

### BACKGROUND OF THE INVENTION

Personal containers for firearms magazines such as those compatible with handguns are well known in the prior art. These containers generally hold reserve magazines for reloading the firearm at a moments notice. Thus, the efficacy of such containers is judged by the speed of access to the magazine, and the ability of the container to keep the magazine in a functionally reliable state.

Presently prior art magazine containers utilize pouches wherein magazines are held inside the pouches via gravity. In open-top designs, the magazines themselves exposed to the elements, such as water or sand. These elements can contaminate the magazine, potentially causing an undesirable and potentially dangerous malfunction.

Closed-top designs attempt to fix this problem by providing a roof for the pouch. Such roofs are generally secured to pouch via velcro or button fasteners. To access the magazines, a user must generally open the pouch and retrieve the magazine. This is time consuming and inefficient. Furthermore, the roof does not provide a substantially water-resistant seal with the pouch and therefore is ineffective in situations where near total or complete submersion of the container is necessary. For example, in amphibious or desert combat.

Thus, there is a demand for an easily accessible and substantially element-resistant container for firearms magazines.

### SUMMARY OF THE INVENTION

An ammunition magazine holder herein described overcomes the deficiencies of the present designs noted above.

The primary objective of this invention is to enhance the convenience of firearm magazine carriers.

Another objective of this invention is to provide a system and apparatus for ejectably retaining an ammunition magazine in a substantially water-resistant compartment of a capsule.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIGS. 1a and 1b illustrate a side plan view of an embodiment of the present invention in a locked and unlocked state;

FIGS. 2a and 2b illustrate a side plan view of an embodiment of the present invention in a locked and unlocked state;

FIG. 3 illustrates a side perspective view of an embodiment of the present invention;

FIG. 4 illustrates a side perspective view of a firearms magazine according to an embodiment of the present invention;

FIG. 5 illustrates a side plan view of an embodiment of the present invention as taken along line A-A of FIG. 3;

FIG. 6 illustrates a side plan view of an embodiment of the present invention as taken along line A-A of FIG. 3.

### DETAILED DESCRIPTION OF THE PREFERRED EMBODIMENTS

The above described drawing figures illustrate the described invention and method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present apparatus and its method of use.

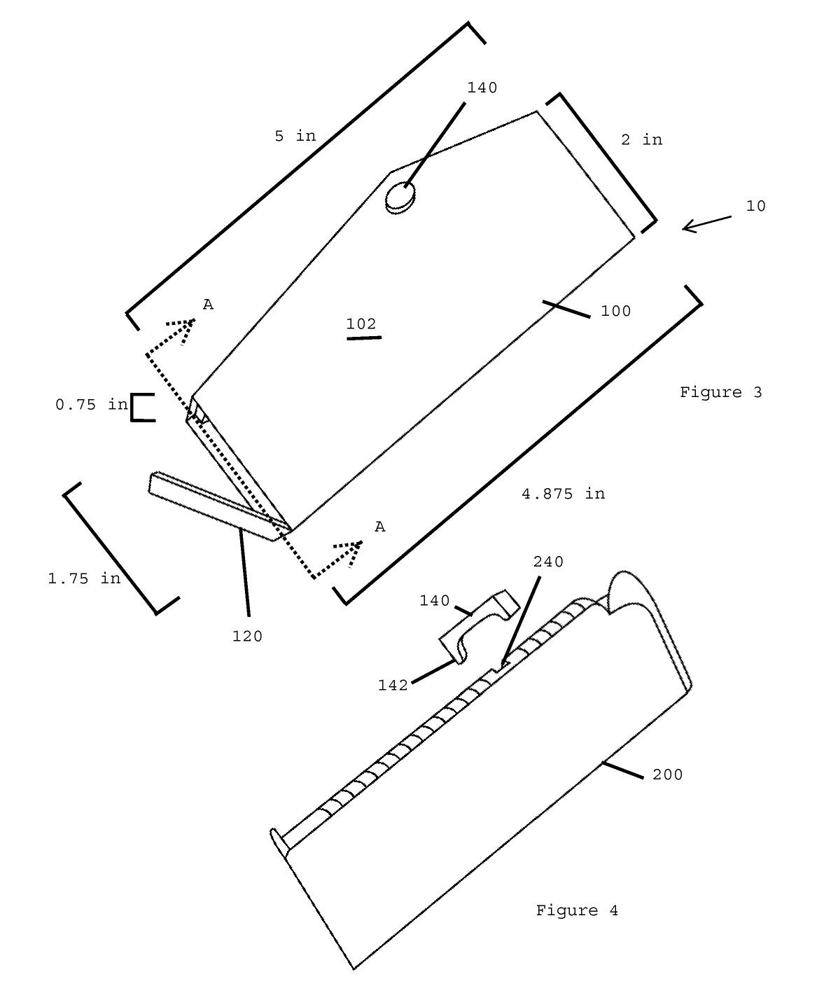

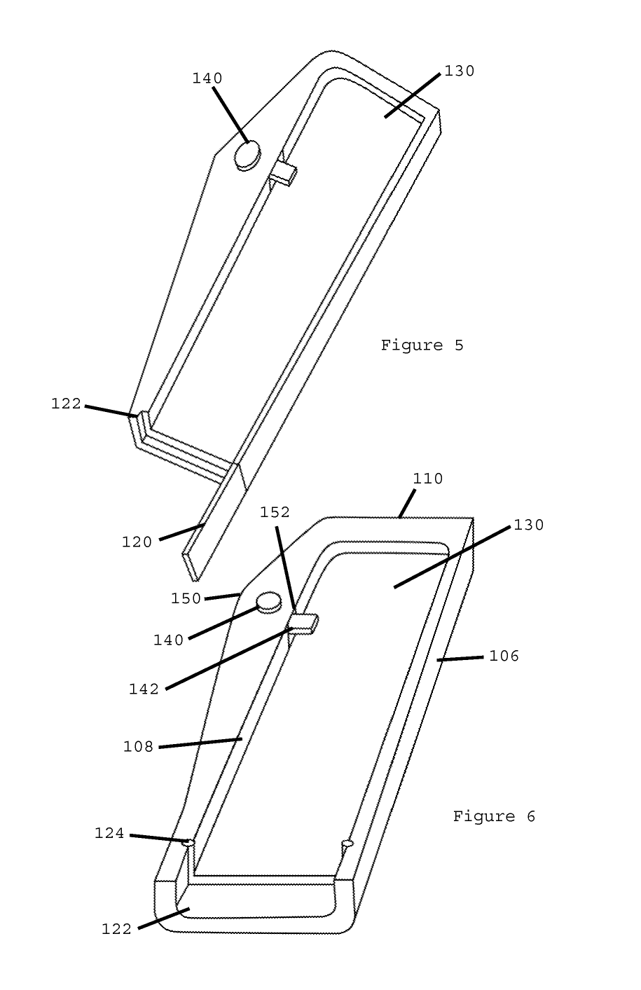

As shown in FIGS. 3 and 4, an ammunition storage unit 10 comprises an ammunition magazine 200; and a capsule 100 for ejectably retaining the magazine 200 therein.

As shown in FIG. 4, the magazine 200 is preferably a magazine for storing ammunition for a hand gun or other firearm, and may comprise a notch 240 thereon.

Turing to FIG. 6, the capsule may comprise a substantially rectangular vessel 130 having substantially parallel first 102 and third 104 walls perpendicularly adjoined to substantially parallel second 106 and fourth 108 walls. A top wall 110 may be perpendicularly adjoined to the first through fourth walls 102-108 to form the vessel 130. The first through fourth walls 102-108 may form a bottom edge 122 opposite the top wall 110. The capsule is preferably hard-bodied.

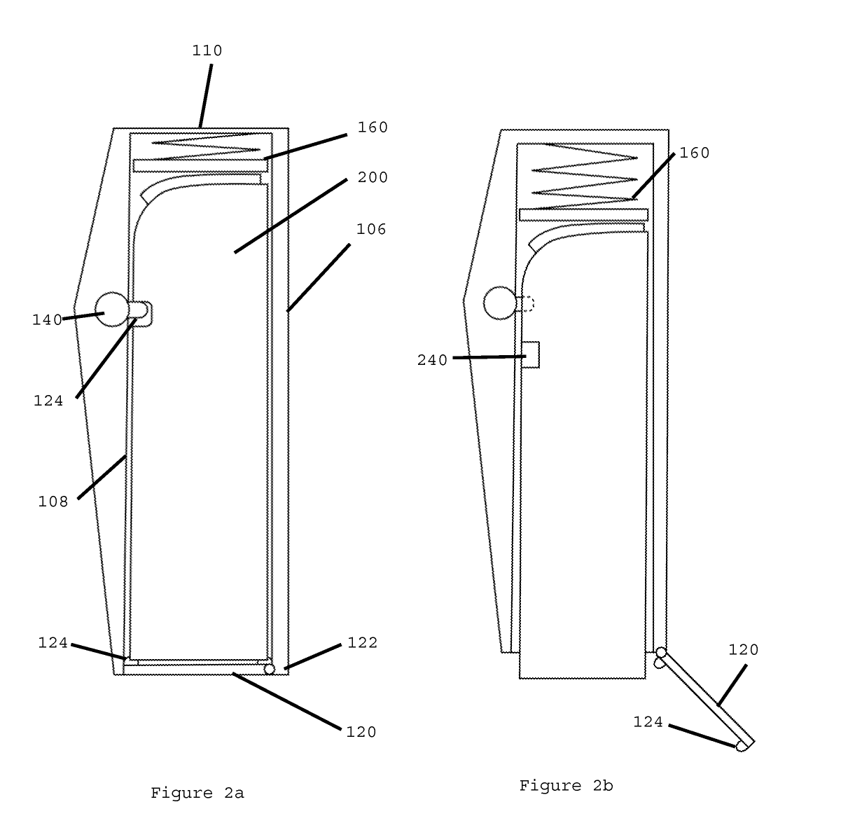

As shown in FIG. 2, the capsule 100 may further comprise a removable base 120 opposite the top wall 110. The base 120 may be operable to engage the bottom edge 122 so as to form a substantially water-tight seal therewith. The seal may substantially prevent water, sand and other similar particles from entering the vessel and interacting with the ammunition and/or the magazine.

The base 120 may be hingedly affixed to the bottom edge 122. A gasket 124 may be provided adjacent the bottom edge 122 of the capsule to engage the base 120 so as to form the substantially water-tight seal. A latch (not shown) may keep the base 120 and bottom edge 122 engaged. Alternatively, a base periphery may comprise the gasket 124, the gasket 124 engaging the bottom edge 122 so as to form the substantially water-tight seal.

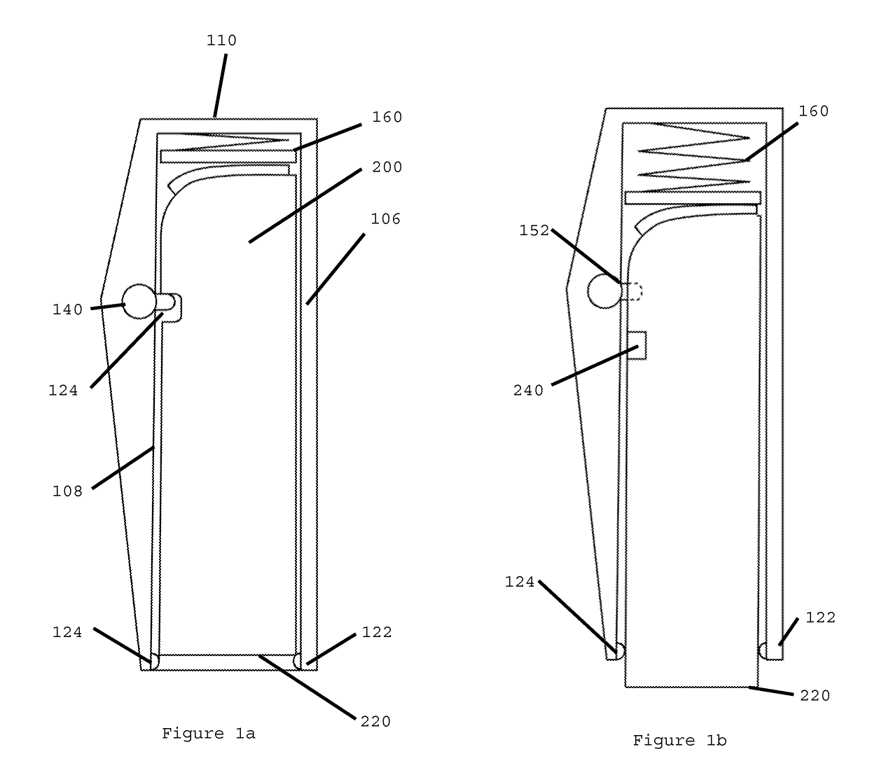

As shown in FIG. 1, the base 120 may also comprise a magazine base 220. The gasket 124 may be provided adjacent the bottom edge 122 of the capsule to engage the magazine base 220 so as to form the substantially water-tight seal therebetween.

The fourth wall 108 may comprise an inner surface and an annex 150 that extends substantially perpendicular to the inner surface, illustrated in FIG. 6. The annex 150 may house an actuator 140 having a tab 142 operable to engage the magazine notch 210 through an aperture 152 on the inner surface so as to retain the magazine 200 within the vessel 130 when the tab 142 and notch 210 are engaged, and to cause the magazine 200 to be ejected from the vessel 130 when the tab 142 and notch 210 are not engaged, as discussed below.

As shown in FIGS. 1 and 2, the capsule 100 may further comprise an ejector 160 operable to provide an ejection force to the magazine 200. The ejector 160 may be a spring actuated ejector located adjacent the top wall 110 that provides an ejection force to the magazine 200 when the magazine 200 is inserted into the vessel 130. As the magazine 200 in inserted into the vessel 130, the ejector spring may be compressed. When the magazine 200 reaches an engagement point, the notch 210 may automatically engage the tab 142 so as to provide a catch for restraining ejection and maintaining the magazine 200 in a locked position. As shown in FIG. 1, in some embodiments, the engagement point may be such that the magazine base 220 and bottom edge form the substantially water-tight seal discussed above.

The actuator 140 may be operable to be in an unlocked position, wherein the tab 142 may disengage the notch 210. Thus, the magazine 200 may be no longer restrained and the ejector 160 may cause the magazine 200 to be ejected from the vessel 130. In embodiments where the latch (not shown) keeps the base 120 and bottom edge 122 engaged, the ejection force may be sufficient to disengage the latch, thereby causing the base 120 to disengage the bottom edge 122, permitting the magazine 200 to eject through the bottom edge 122. In embodiments where the base is the magazine base 220, the ejection force may be sufficient to overcome the gasket seal between the base 220 and the bottom edge 142.

The enablements described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. An ammunition storage unit comprising:
an ammunition magazine;
a hard-bodied capsule for retaining the magazine internal thereto, the capsule having a bottom edge;
a removable base adjacent the bottom edge so as to form a substantially water-tight seal when the magazine is in a locked position; and
an actuator operable to retain the magazine internal to the capsule, the actuator further operable to cause the magazine to be ejected from the capsule in the direction of the base when the magazine is in an unlocked position.

2. The ammunition storage unit of claim 1, further comprising:
a magazine notch for accepting an actuator tab so as to maintain the magazine internal to the capsule when in a locked position;
wherein removal of the tab from the notch causes the magazine to be ejected from the capsule.

3. The ammunition storage unit of claim 2, further comprising:
an ejector for providing an ejecting force to the magazine;
wherein removal of the tab from the notch permits the ejector to eject the magazine from the capsule.

4. The ammunition storage unit of claim 1, wherein the base is hingedly affixed to the bottom edge.

5. The ammunition storage unit of claim 1, wherein the base comprises a magazine base.

6. The ammunition storage unit of claim 1, further comprising a first gasket approximate the bottom edge, the first gasket operable to engage the base and bottom edge so as to form a substantially water-tight seal when the magazine is in a locked position.

7. A method for storing ammunition comprising:
inserting an ammunition magazine into a hard-bodied capsule having a bottom edge and a removable base adjacent thereto;
retaining the magazine within the capsule via an actuator placed in a locked position;
engaging the bottom edge to the base so as to form a substantially water-tight seal; and
ejecting the magazine from the capsule by placing the actuator in an unlocked position.

8. The method of claim 7, further comprising:
providing a magazine notch for accepting an actuator tab so as to maintain the magazine internal to the capsule when the actuator is in a locked position;
wherein ejecting the magazine comprises removing the tab from the notch.

9. The method of claim 8, further comprising:
providing an ejecting force to the magazine;
wherein removing the tab from the notch permits ejection by the ejecting force.

10. The method of claim 7, wherein the base is hingedly affixed to the bottom edge.

11. The method of claim 7, wherein the base comprises a magazine base.

12. The method of claim 7, wherein engaging the bottom edge to the base further comprises providing a first gasket approximate the bottom edge.

13. A system for storing ammunition comprising:
a hard-bodied capsule for ejectably retaining an ammunition magazine in a substantially water-resistant compartment thereof.
